(19) United States
(12) Patent Application Publication
(10) Pub. No.: US 2023/0294149 A1
(43) Pub. Date: Sep. 21, 2023

(54) Detritivore Lavatory

(71) Applicant: Gregory Lyle Walker, Harvey, IL (US)

(72) Inventor: Gregory Lyle Walker, Harvey, IL (US)

(21) Appl. No.: 17/834,736

(22) Filed: Jun. 7, 2022

Related U.S. Application Data
(63) Continuation of application No. 17/698,739, filed on Mar. 18, 2022.

(51) Int. Cl. B09B 3/60; A47K 11/02

(52) U.S. Cl. CPC B09B 3/60; A47K 11/02; B09B 2101/70

(57) ABSTRACT

The purpose of the Detritivore Lavatory [D-Lav] Sanitation Machine/Mechanism invention is to bio-convert human wastes and food scraps into viable commodities through the efficient use of detritovores. While providing protections against Covid-19 and other disease transmissions and ecological pollution, as well as mitigating greenhouse gases. The D-Lav invention facilitates the safe, sustaining and efficient use of detritovores in a controlled aerated environment in order to facilitate the bio-conversion of multiple forms of biodegradable substances.

The D-Lav invention solves a variety of problems experienced in the field of compost toilets generally and enhances the detritovore based Biofil Microflush Toilet system approach specifically. The use of the D-Lav invention will also permit multiple types of production alternatives. Such as nutrient dense soils, fertilizers, bio-fuels and animal feeds that can be derived from this invention.

Title/Description: The Detritivore Lavatory [D-Lav] Sanitation Machine/Mechanism—A self-contained, low water use sanitation station for the capture, containment and biological transformation of human urine, menses blood, hair, bio-degradable toilet tissue, feces and food scraps. All of which the D-Lav can bio-convert into viable marketable commodities. While protecting against viral disease transmissions for the invention's users. As well as presenting no negative ecological impacts and effectively mitigates greenhouse gases.

### TECHNICAL FIELD: DESCRIPTION OF THE RELATED ART

Any discussion of the prior art throughout the specification should in no way be considered as an admission that such prior art is widely known or forms part of common general knowledge in the field.

During the Roman era and up through the 1960's there have been attempts at recycling and/or repurposing human urine/feces, available food/table scraps and other biologically generated wastes. Such as plant wastes through composting, for example. This has been sought by inventors in ways which altered devices, such as the common toilet. To adding a variety of ingredients to pit latrines that eliminated or repurposed waste products. These approaches have been ventured in order to achieve recycling goals, to reduce the impact of greenhouse gases through a variety of initiatives or to improve sanitation conditions. While there have been many strides in this field of endeavor, most have been inefficient, cumbersome, costly and inadequate in fulfilling such goals.

Inventions such as the a) Decomposition Toilet [U.S. Pat. No. 4,633,535A], an apparatus for treating biological waste by means of composting, (Problem 1) only reduces the likelihood of bacteria forming through its heating element approach in the decomposition process. The b) Toilet Installation Implementing Composting with Worms method [U.S. Pat. No. 6,601,243B2] utilizes detritivores. However, (Problem 2) it is bulky, requires many materials, and is labor intensive. The c) Composting device for Toilet and Kitchen Waste [U.S. Pat. No. 5,171,690A] effectively permits the different stages of composting not to be uneven due to its different container method and humidity aeration approach. However, (Problem 3) like all composting devices, it limits the user/individual who may not be able to utilize the composting material that results. Preventing its use from being widespread. As well as producing a material for a singular use [composting].

Finally, d) the Biofil Microflush Toilet systems approach, while combining the benefits of a water flush toilet system and those of composting toilets, can be cumbersome and labor intensive. (Problem 4) Relies on regular water use for operations which can also contribute to disease transmission through toilet water flushing devices. Or aerosol producing systems. For example, the study, “Evidence of Airborne Transmission of Severe Acute Respiratory Syndrome Virus,” determined that the SARS outbreak in China was due to the virus being airborne spread. Also see FIG. 26) for an illustration of this phenomena. (Problem 5) It must further be noted while all these Related Art approaches can contribute to many sanitary conditions. There are critical times where contaminations are very likely during different stages of their operations and maintenance.

### BACKGROUND ART OF THE FIELD OF INVENTION

A summary of the background art in the field of inventions are provided. This invention, patent U.S. Pat. No. 6,601,243B2, relates to a composting toilet installation comprising: a toilet seat placed over a gravity outlet opening; receiver means for receiving liquid effluent, fecal matter, and other wastes. The installation further comprises in the storage zone: a composting medium constituted in particular by the fecal matter and other wastes brought in by the displacement means and containing worms of a variety suitable for transforming the fecal matter and other waste into compost; and dampening means for keeping the composting medium damp other than by means of urine. See FIG. 29).

Next is a composting toilet comprising a housing having a seat disposed about an opening communicating with an aeration drum for receiving human waste matter, U.S. Pat. No. 5,345,620A. The drum is rotatably-mounted for rotation about a longitudinal axis oriented horizontally inside the housing. A removable receptacle adapted to receive decomposed solid waste matter from the aeration drum for periodic removal from the toilet is also provided. This invention relates to composting toilets. In particular, the invention is directed to improvements to an aeration drum used in composting toilets for aeration of the decomposing waste and mixing the waste with added organic matter. See FIG. 30).

The Biofil Digester is a simple compact on-site organic waste treatment system that uniquely combines the benefits of the flush toilet system and those of the composting toilets and eliminates the disadvantages and drawbacks of both systems. The Biofil Digester technology mimics the decomposition found under forests' floors and other natural environments. Living organisms (both microorganisms and macro-organisms such as earthworms) in an enclosed environment treats all organic degradable matter through the natural process of aerobic decomposition. See FIG. 31).

### DISCLOSURE OF INVENTION: BRIEF SUMMARY OF THE INVENTION

The Detritivore Lavatory [D-Lav] Sanitation Machine/Mechanism objectives as an invention are met by overcoming the problems and limitations associated with prior art in the field. Principally by (Solution 1—Process Manufacture) appropriately aerating the biochar, black soldier-fly and worm compartments, in order to facilitate detritovore viability. In addition, applying a recently discovered technique of utilizing a low light source that can assist in maneuvering black soldier-flies during the consumption of waste has been achieved. In the article “Do It By Yourself: Larval Locomotion in the Black Soldier Fly Hermetia illucens, with a Novel “Self-Harvesting” Method to Separate Prepupae”, utilized six lumens of light positioned strategically in a waste processing container of black soldier-flies. Resulted in older black soldier-fly movements in the container which offered an inexpensive self-harvesting system that can be implemented in small-scale and industrial farming. This Manufacturing process the inventor refers to as the “Feed Efficiency Light Herding Self Harvesting Mechanism” of the device.

All of the above solutions have been of significant difficulty to achieve by inventors in the field. This arrangement also contributes to bacteria being less likely to form. (Solution 2—Process Manufacture) Efficient and compact design as compared to Related Art, which allows users/individuals to deliver urine, feces, hair, menstrual blood, bio-degradable toilet paper and food scraps to decentralized compartments for the processing by [olivine and biochar] detritivore bio-conversion processes. (Solution 1) Due to the immediate solid and liquid waste delivery to detritivores, as well as the olivine treated biochar, odors are effectively eliminated before there is time for bacterial formation or thorough decomposition of substances contained to initiate. (Solution 4—Method of Use) The Machine/Mechanism efficiently utilizes yet contains water within a flush-less system. This further solves the problems related to environmental water runoffs, water treatment issues and disease-causing aerosol dispersals, FIGS. 26) and (28).

All substances, food scraps, feces, hair, menstrual blood and urine are received in separate containers consisting of; black soldier fly larvae with olivine treated biochar; earthworms, gravel and hair, and a container/receptacle where all substances are collected for further bio-converting, respectively. (Solution 3—Method of use Patent) This would also permit multiple types of production alternatives. Such as nutrient dense soils, fertilizers and animal feeds that can be derived from this invention. (Solution 5—Method of use Patent) This invention also affords significant protections from various contaminations or transmissions of viruses, by being flush-less and through its use of detritivores. As well as possessing a Nano-Care™ anti-microbial surface coating that reduces bacterial and viral transmissions while in use, FIG. 1-10a).

### SPECIFICATION EXAMPLES: D-LAV OPERATIONS AND UNIT COMPONENT FUNCTIONS

(Process Manufacture) The Detritivore Lavatory [D-Lav] Sanitation Machine/Mechanism consists of a rectangular multilevel box with an upright male urinal and horizontal female urinal and three entrances on the surface of its Receiving Platform-Stand that is designed to hold up a human being. While a human using it via stooping, with the assistance of one large and two small stability bars, FIGS. 4) and (5) respectively. The Receiving Platform-Stand, Sealing Lid, with Baby Changing section and Urinal attachment acts as a sealant covering the three entrances to the mechanism while not in use, FIGS. 8) and (9). Once the Receiving Platform-Stand and Urinal attachment are separated, human feces, urine, hair, blood menses and bio-degradable toilet paper can be placed in the appropriate entrances for processing in the Detritivore and Treated Biochar Bin, FIGS. 10), (11-50, 52, 54a, 54b, 54c, 54d, 58a, 58b) and (21-70). As well as in the Olivine Treated Biochar Bin, FIG. 23-80).

The D-Lav Machine/Mechanism consists of two dual pylons that encase the rectangular detritovore and biochar container/boxes. Otherwise denoted as Access Forward Mounting Pylon, and Access Rear Mounting Pylon, FIGS. 4-20) and (6-30) respectively. Both pylons have affixed an adjoined support function bar/brace. The AFMP's bar/brace acts as support/brace for the individual user. While the ARMP's Pylon foundation brackets, with adjoining pole, permits the hanging of two Sanitation ‘Tippy Tap’-Water Jug containers. One jug is filled with anti-bacterial soap and the other with clear water. ‘Tippy Tap’ Ribbon/Strings, tied to the jugs are attached to the two small utility Suspension Posts on either side of the box. Which by way of a connecting and detachable Suspension Cross Bar, overlooks the mechanism's Baby Changing Table, FIGS. 6) and (7-32, 34a, 34b, 34c, 34d, 36, & 38).

Said rectangular multilevel box's surface is coated with a Nano-Care™ antiviral, hydrophobic slick coating to maintain a sanitary state, FIG. 1-10a). Reducing/eliminating the likelihood of bacterial and viral disease transmissions. Inside the rectangular multilevel box are two containers, consisting of the detritivore bio-conversion housing units. The top-forward container houses detritivores called black soldier-fly larvae in the D-Lav Prime Core Box, FIGS. (14-60). Within the black soldier-fly and olivine treated biochar compartment are two sets of Pagoda Feeding Ramps/Platforms between and within which the compartment's dual-wheel detritivore and feces/food scraps rotator wheel acts as a detritivore eating delivery processor, FIGS. 16-64a & 86′a) and (17). Said Feeding Ramps and dual Feeding Wheels are designed to allow the catching and circular movement of feces and food waste for easy access and consumption by the larvae.

The Forward wheel rotates food waste, FIG. 16-64b). While the rear wheel [FIG. 76] rotates feces, (16-64a). Then through a canopy shaped lid shielding the mechanism's entrances, permits light to enter into it. Utilizing a low light source and clear canopies treated with a drying substance, will be able to internally maneuver adult black soldier-flies away from the younger larvae so that they can increase the consumption of the waste matter present. This Manufacturing process the inventor refers to as the “Feed Efficiency Light Herding Self Harvesting System” of the D-Lav, FIG. 16-68′a, 68′b, 68a, 68b).

The utilization and effectiveness of the black soldier-fly larvae as a bio-conversion conduit has been well documented. For instance, in the article, “Sustainable Waste Management at Household Level with Black Soldier Fly Larvae (Hermetia illucens)”, the study evaluated the practicability of black soldier-fly bin use at the household level to handle kitchen biowaste. It found that the use of black soldier-flies in bins consuming bio-wastes were effectively managed at the source of waste production at the household level.

Two [4.72×4.72×0.98 inches] miniature cooling fans affixed inside the Support Bar, FIG. 4). Which blow air from outside the box into hollow walls that transfer the air to aeration tubes extending from the walls into the area holding the black soldier fly larvae and olivine treated biochar, FIGS. 5-24b & 24c). The mechanism's utilization of an aeration tubes system was determined to be most effective in a recent study involving what researchers referred to as an air-fluidization process. From the article, “Air-Fluidized Aggregates of Black Soldier fly Larvae”, the study determined that proper aeration experienced while black soldier-flies are feeding, reduces confined area temperatures, which increase while black soldier-flies are consuming. This often results in their deaths while feeding in bins. The findings of the study showed that black soldier-fly deaths could significantly be reduced by proper aeration, which this mechanism provides. Two Suspension Posts positioned on both ends of the box on either side, hold up the Suspension Cross Bar. Said bar holds two empty common household jugs, one filled with soap and the other clear water, FIGS. 6), (7-34b, 34c & 34d). Strings tied to the jugs are attached to the two small utility bars on either side of the box. Which allow for ‘Tippy Tap’ utilization.

### SPECIFICATION EXAMPLES: BRIEF DESCRIPTION OF THE DRAWINGS

FIG. 1) An intact and ¾ aerial view of a portable Detritivore Lavatory [D-Lav] multifunctional sanitation and bio-conversion system [10]. Along with the identification of its Nano Carer™ Anti-Viral Slick Sealant [10a].

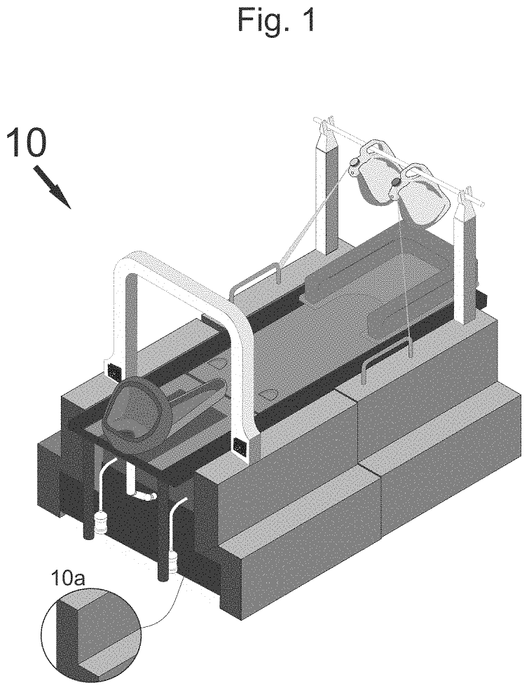

FIG. 2) Side view of Detritovore Lavatory [D-Lav] Mechanism/Machine [10].

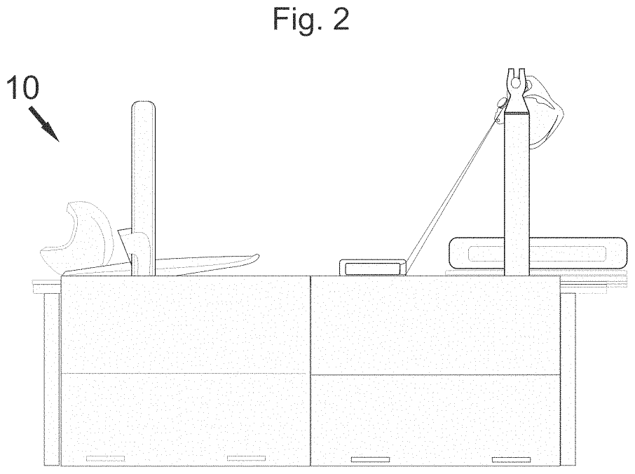

FIG. 3) ¾ths Aerial [exploded] view of the Detritovore Lavatory Mechanism/Machine depicting seven key units of the Forward Mounting Pylon Staircase [20], Rear Mounting Pylon Staircase [30], Receiving Platform Assembly [40], Sealing Lid [50], D-Lav Core Bio-Regenerative Mechanism/Machine [60], D-Lav Prime Bio-Regenerative Box [70], and the Biochar Enrichment Bin [80].

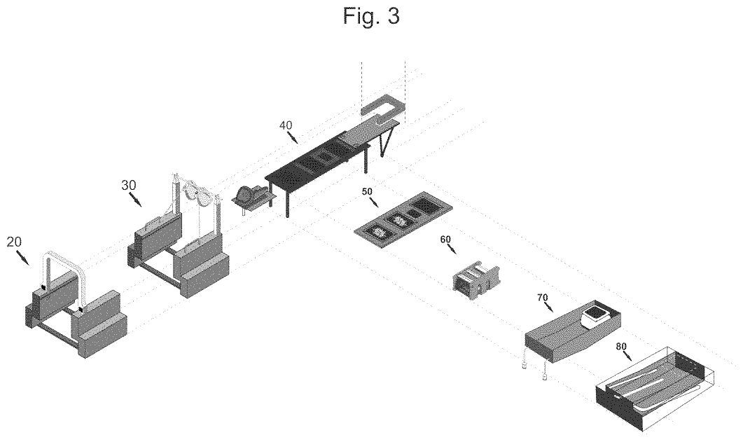

FIG. 4) 1^{st} Unit ¾ths Aerial view of Forward Mounting Pylon Staircase.

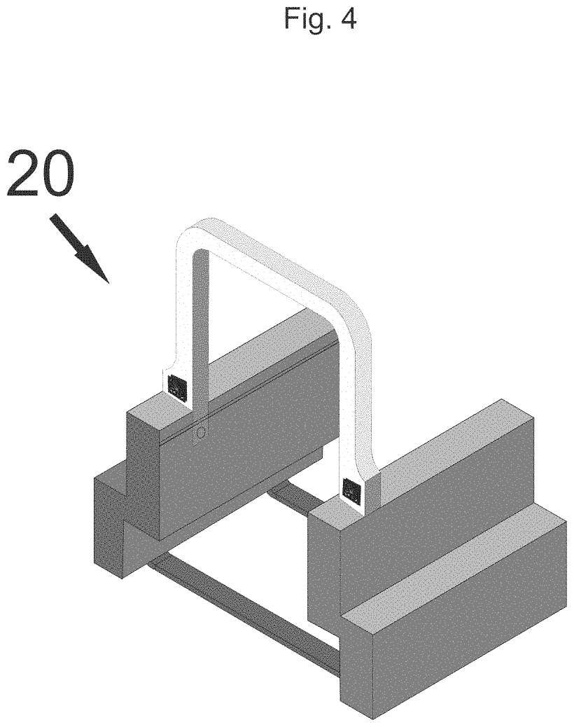

FIG. 5) Side view of Forward Mounting Pylon Staircase (access) [20]. Along with its key features consisting of; Pylon Staircase [22], Brace-Bar [24a], Cooling Fans (2 total) [24b], Aeration Channel [24c], Pylon Foundation Brackets (1 pair) [26].

FIG. 6) 2^{nd} Unit ¾ths Aerial view of Rear Mounting Pylon Staircase [30].

FIG. 7) Side view of Rear Mounting Pylon (access) [30]. Along with its key features consisting of; Rear Mounting Access [32], Lavatory Suspension Posts [34a], Lavatory Suspension Crossbar [34b], Lavatory Sanitation Liquid (water) Containers [34c], Tippy Tap Ribbon (1 pair) [34d], Balancing handles [36], Rear Pylon Foundation Brackets (1 pair) [38].

FIG. 8) 3^{rd} Unit ¾ths Aerial view Receiving Platform Assembly [40].

FIG. 9) Receiving Platform Assembly [40], with attached Urinal (46a & 46b) and Changing Table (42b, 48b, 49a & 49b). Along with key features consisting of; Receiving Platform (main table) [42a], Baby Changing Sliding Tabletop [42b], Food Portal [44a], Prime Portal (stool depot) [44b], Disposables (Menses Port) [44c], Lavatory Portal [4d], Attached Female Urinal [46a] and Male Urinal [46b], Urinal Tabletop Sliding Platform [46c], Urinal Drain Pipe [46d], Receiving Platform Legs (4) [48a], Baby Changing Sliding Tabletop Retractable Leg [48b], Baby Changing Guard [49a], and the Baby Changing Mat [49b].

FIG. 10) 4^{th} Unit ¾ths Aerial view of the Sealing Lid [50].

FIG. 11) Side view of the Sealing Lid [50]. Along with key features consisting of; the Sealing Lid Platform [52], Sealing Lid Food Portal [54a], Sealing Lid Prime Portal [54b], Sealing Lid Menses Port [54c], Sealing Lid Lavatory Portal [54d], Sealing Lid Food & Prime Guide Cover [56], Food Dispersion Grill/Rack [58a], and the Prime Dispersion Grill/Rack [58b].

FIG. 12) Food Dispersion Grill/Rack (top view) [58a].

FIG. 13) Prime Dispersion Grill/Rack (horizonal/side view) [58b].

FIG. 14) 5^{th} Unit ¾ths Aerial view of the D-Lav Core Bio-Regenerative Mechanism/Machine [60].

FIG. 15) Schematic D-Lav Core/Aeration (horizonal/side view) [62′a, 62′b, 62′c & 62d]. Including its key components of: Aeration Panel [62′a], Aeration Chanel [62′b], Convex/Concave Aeration Contact Discs [62′c], and Aeration Tubes (10) [62d].

FIG. 16) Schematic D-Lav Core (horizonal/side view). Along with key features including; Core BSFL Biochar Encasement [63], BSFL Prime Feeding Wheel [64a], BSFL Food Scraps Feeding Wheel [64b], Prime Wheel Bearings [64′c], Food Wheel Bearings [64′d], Hydrophobic Food Ramp Support Topper [65a], Hydrophobic Food & Bio-Regenerative Ramps support Topper [65b], Hydrophobic Bio-Regenerative Ramp Support Topper [65c], BSFL Prime Crossing Ledges [66a], BSFL Food Crossing Ledges [66b], Transparent Plexi Glass Core Encasement [67′], Prime Side Light Herding Self Harvesting Pagoda Platforms [68′a], Food Side Light Hearding Self Harvesting Pagoda Platform [68′b], Prime Side Light Herding Self Harvesting Pagoda Platform [68a], Food Side Light Herding Self Harvesting Pagoda Platform [68b], Frass Screen [69a], Self Harvesting Tube [69b], Self Harvesting Pathway Tube [69c].

FIG. 17) D-Lav Core/Prime Feeding Wheel and Prime Side Light Herding Self Harvesting Pagoda Platforms, 46a and 68′a featured respectively.

FIG. 18) Prime Side Light Herding Self Harvesting PLATFORMS.

FIG. 19) Visual Depiction of black soldier fly larvae consumption of waste resulting in Greenhouse Gases Mitigation.

FIG. 20) D-Lav Core Bio-Regenerative Mechanism/Machine (Detailed Schematics) [60]. Key features previously addressed in FIGS. 15, 16, 17 and 18.

FIG. 21) 6^{th} Unit, ¾ths Aerial view of D-Lav Prime Bio-Regenerative Box [70].

FIG. 22) 6^{th} Unit, ¾ths Side view of D-Lav Prime Bio-Regenerative Box [70]. Along with key features including; D-Lav Prime Box [72a], Worm Frass Urn [72b], Inner Wall Food Side Core Leveling Ledge [73′a], Inner Wall Prime Side Core Leveling Ledge [73′b], Food Wheel Strut (Wall Fashioned) [73′c], Prime Wheel Strut (Wall Fashioned), Worm Frass Drain Hole [74a], and the Larvae Harvest Containers (2) [74′b].

FIG. 23) 7^{th} Unit, ¾ths Aerial view of Biochar Enrichment Bin [80].

FIG. 24) Biochar Enrichment Bin (side view) [80]. Along with key features including; Biochar Enrichment Bin Hull [82] and the Urine to Biochar Pipe Assembly [84].

FIG. 25) Identify process of virus elimination, by sucking in and aerating contaminated aerosol sprays.

FIG. 26) Identifies the problems caused by virus filled aerosols in traditional toileting systems.

FIG. 27) Identifies how the traditional use of toilets often transfers viruses and other disease transferable pathogens. Absent the anti-bacterial Nano Care™ covered and detritovore virus consuming D-Lav.

FIG. 28) Identifies how traditional sanitation of human biological wastes are largely handled. Absent the D-Lav that could eliminate unsanitary water and waste treatment operations by D-Lav's bio-conversion process.

FIG. 29) Background art in the field of invention, patent U.S. Pat. No. 6,601,243B2. Image relates the instillation device of a composting toilet.

FIG. 30) Background art in the field of invention, patent U.S. Pat. No. 5,345,620A. Image relates the applicability of composting toilets using an aeration drum to limit bacteria and waste odors.

FIG. 31) Background are in the field of invention. Image relates a compact on-site organic waste treatment system that utilizes the combination of a flush toilet system, composting toilet, and detritovores.

### INDUSTRIAL APPLICABILITY: D-LAV FUNCTIONS AND UTILITY

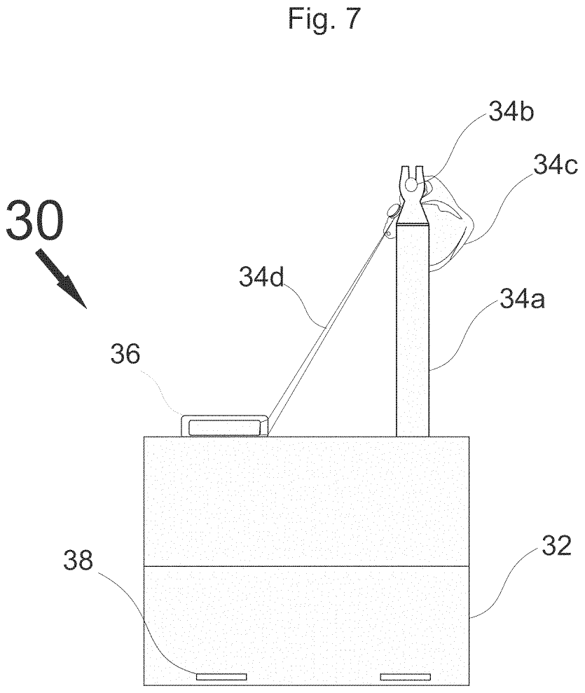

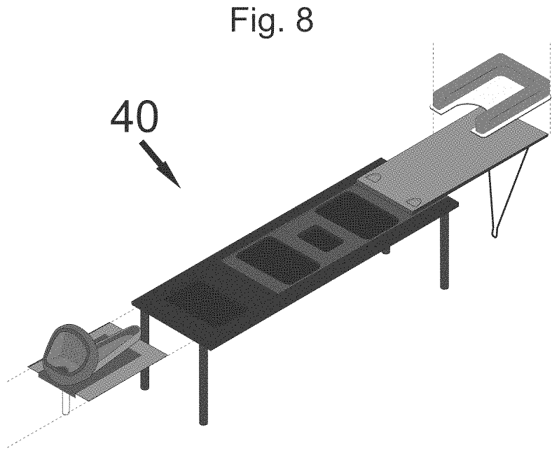

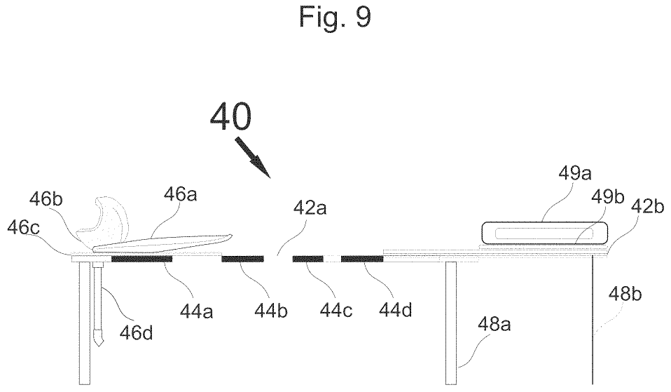

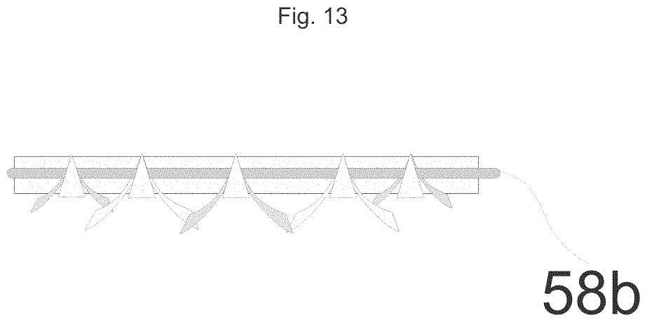

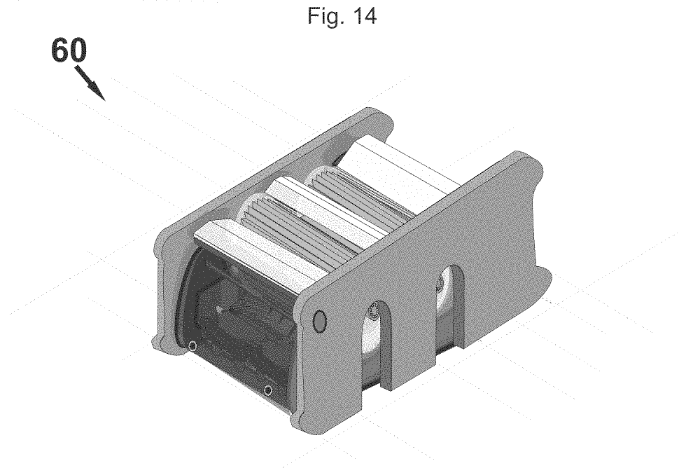

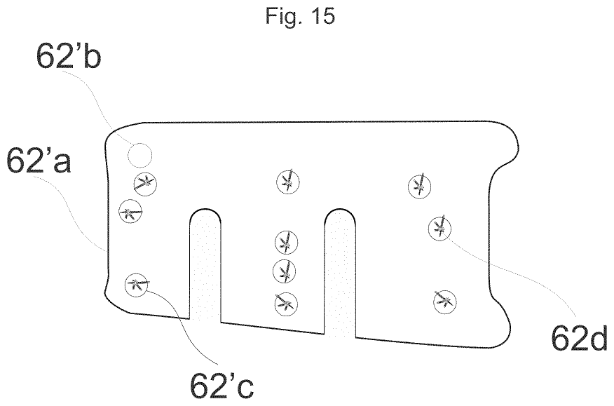

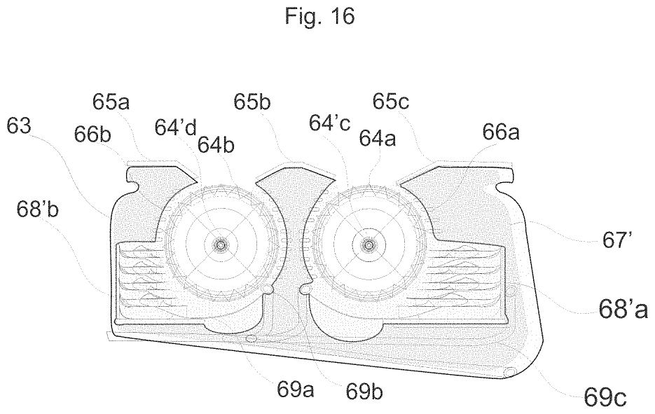

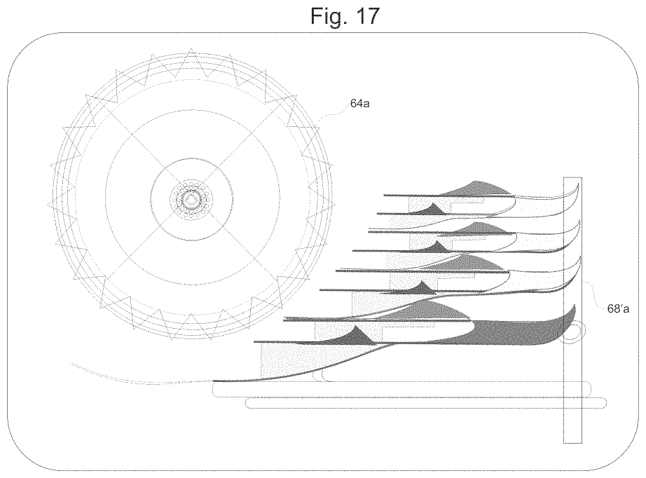

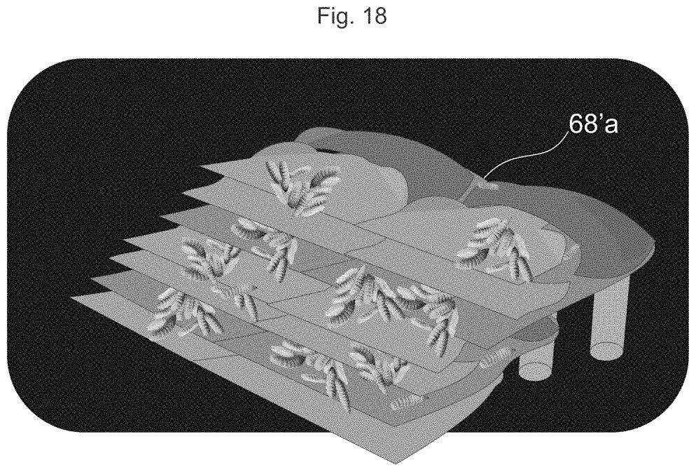

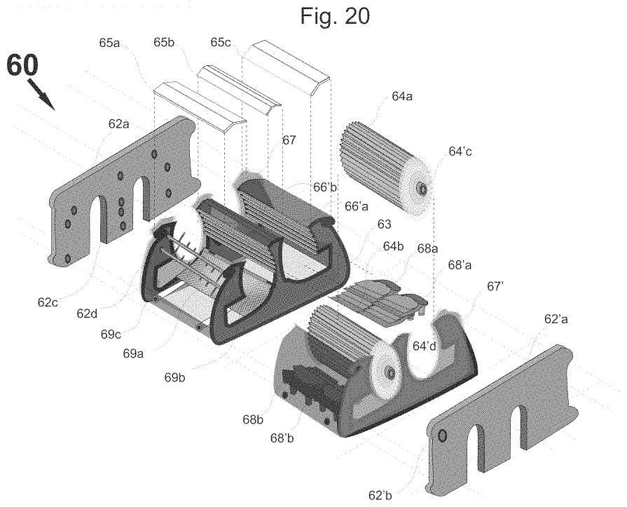

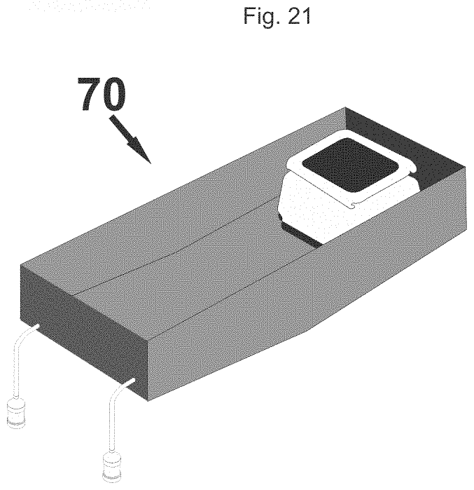

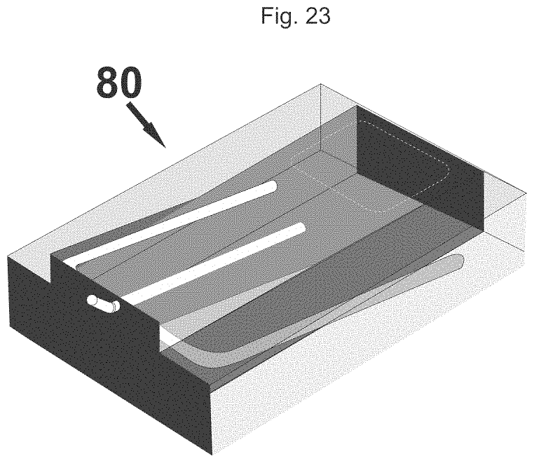

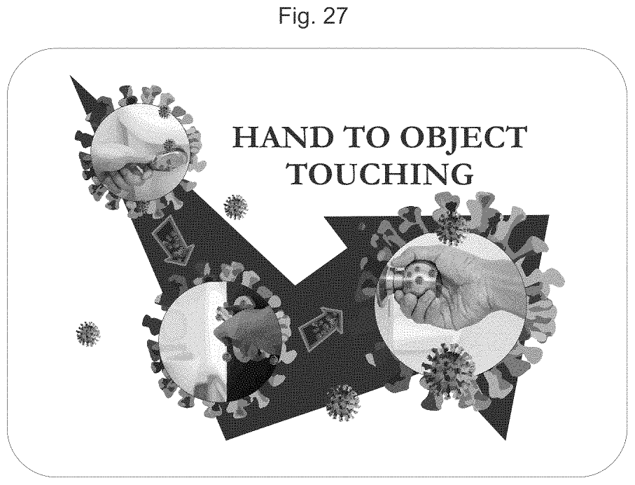

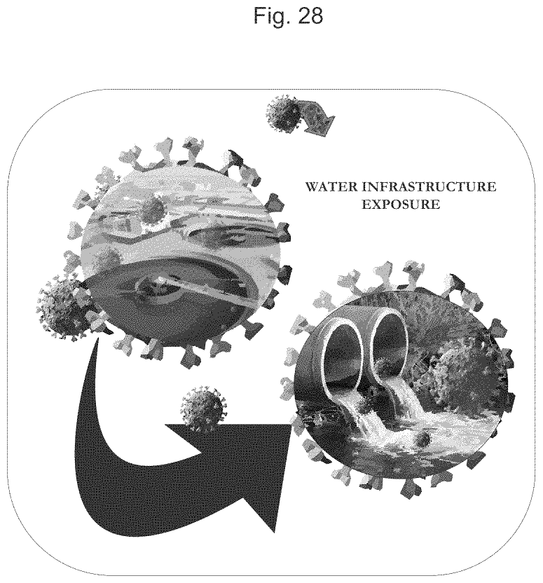

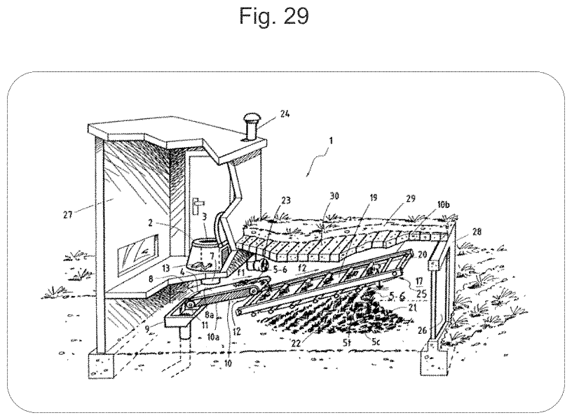

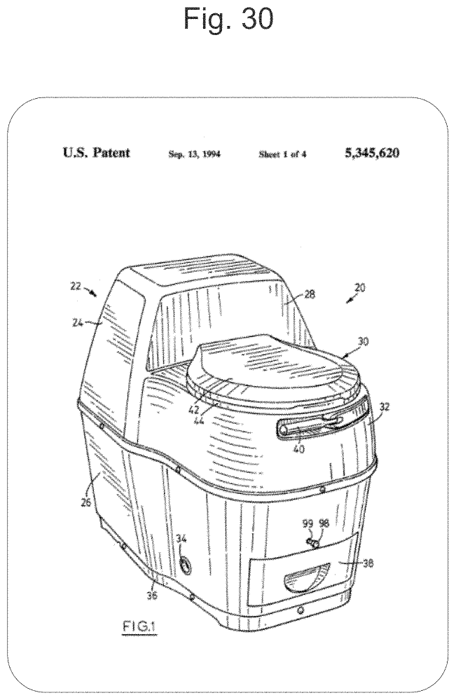

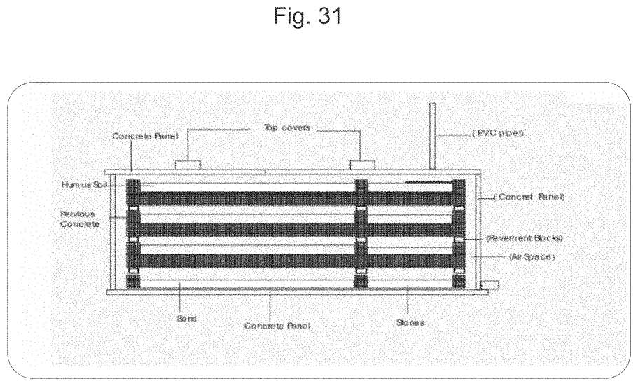

(Method of Use—User) After the User completes defecating into the hole nearest the Support Bar and female urinal, FIG. 9-44b). The User then backs up to hover their posterior over the hole positioned before the ‘Tippy Tap’ jugs, FIG. 9-44d). Using an elbow/available hand pushing the string causes the jug containing soapy water to tilt and stream soapy water over their posterior and into the rinse hole, FIG. 7-34d). User can then wipe posterior with biodegradable toilet paper or with free hand. After hand washing their posterior with biodegradable toilet paper, the User uses the opposite elbow/available hand to push the other string causing clear water to be streamed for rinsing. User can then use biodegradable paper towel for drying. While all biodegradable paper is thrown into the rinse hole/Worm Urn, FIG. 9-44d). Permitting the biodegradable paper to settle into the worm bin below for worm consumption/processing.

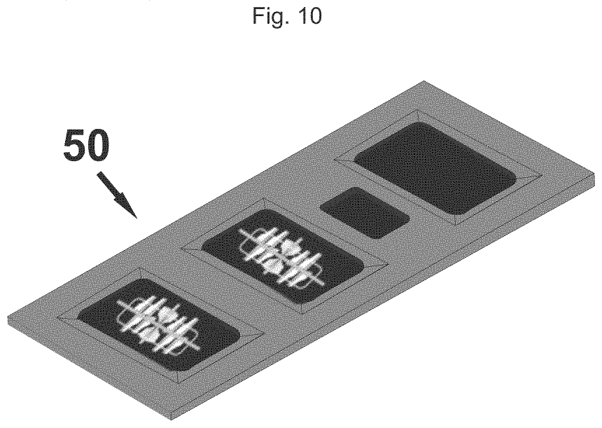

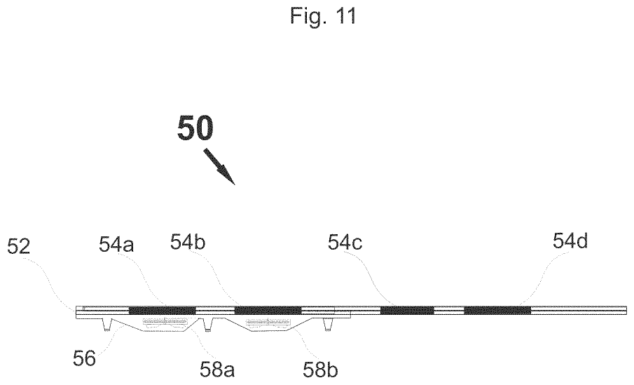

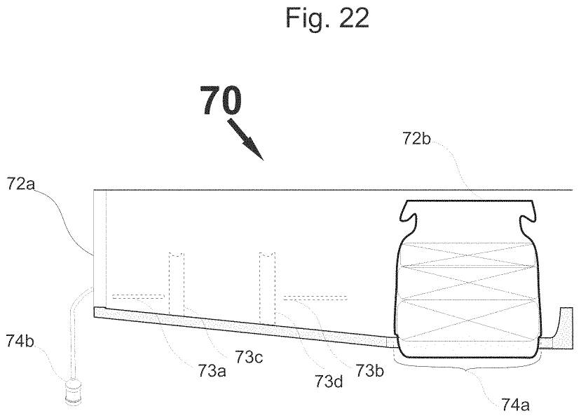

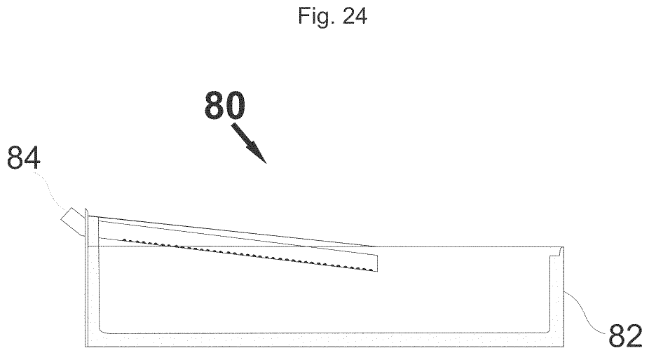

(Method of Use—Processing) While stooping and using Support Bar, User positions him/herself for defecating material to enter rear dual-Feeding Wheel. Where black soldier-fly larvae [and olivine treated biochar] container area will decompose/consume it, FIG. 11-58b). While permitting urine to enter the biochar container area, FIG. 24-84). Defecation material and gravity rotates the forward dual-Feeding Wheel, permitting black soldier-fly larvae to devour from within the wheel and adjoining Feeding Pagoda Ramps/Platforms, FIGS. 10), (11-58b), (12), and (16-64a &. 68′a). Thus, preventing decomposition, bacteria accumulation and lingering odors. While used water flows to the Worm Urn, FIG. 22-74a). Where it soaks into gravel; helps to decompose available hair; and is consumed by earthworms, figure illustration (19).

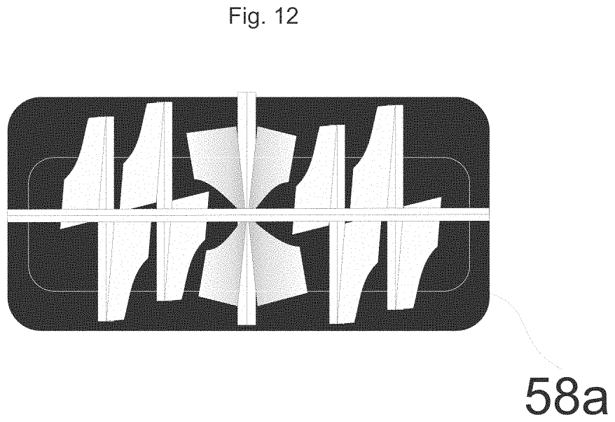

A smaller rectangular hole positioned between the defecation [forward positioned] and wash hole [rear positioned] is used by the User to place clipped body hair and by women to pour menstrual blood into, for black soldier fly larvae to consume, FIG. 9-44c). Where both the blood is consumed by the larvae, and hair [soft lipids surrounding the hair] is entered into this decomposition process. After the hair continues to decompose, the hair is then removed and grounded into small bits. Then added to the bottom bin containing solely olivine treated biochar, FIG. 12). This procedure promotes the accumulation of nitrogen for soil amendment.

A rectangular entrance nearest the Suspension Posts is the rinse hole/Lavatory Port, containing earthworms which engage in the consumption of stained biodegradable paper, soap and black soldier fly larvae frass. The Olivine Treated Biochar Bin sized to match the upper bin [Detritivore and Olivine Treated Biochar Bin—in length] contains biochar which receives the soapy water and worm enzymes filtered down from the worm bin, FIG. 22-72b, 74a). A piping system beneath the male and female urinal allows urine to flow into said bottom bin to enrich it with nutrients for soil amendment, FIGS. 24-82, & 84).

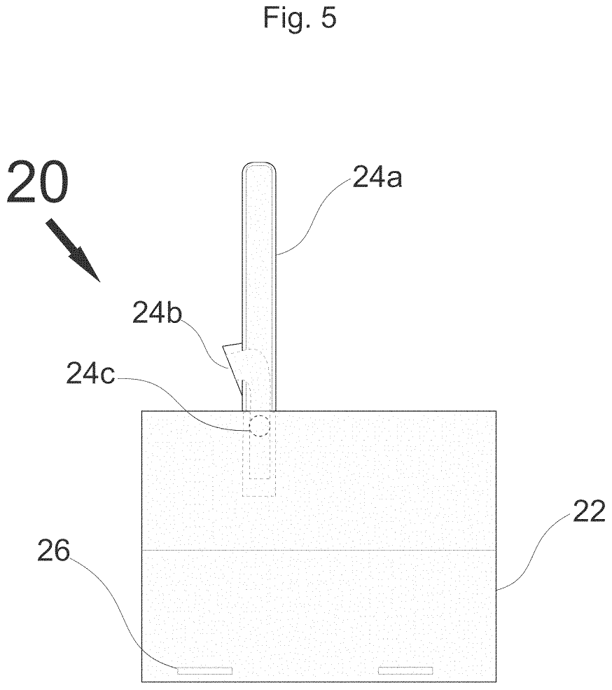

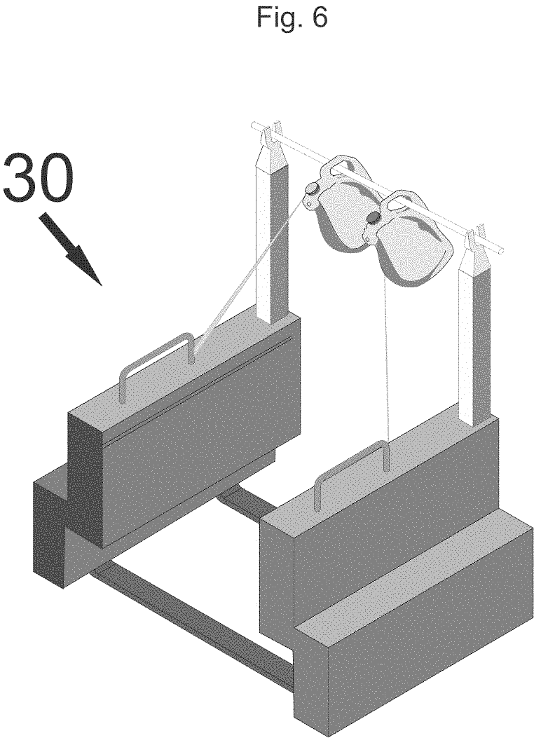

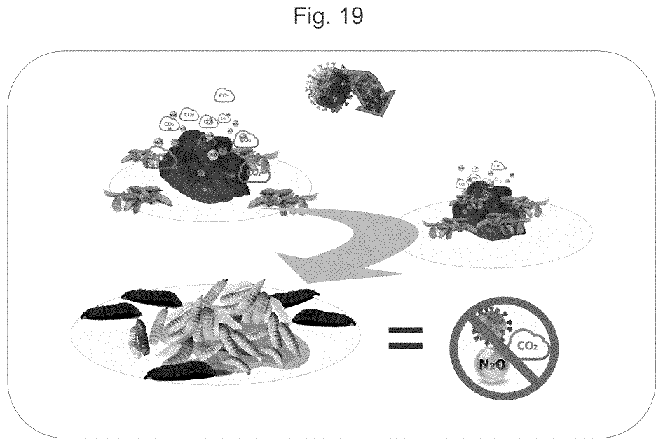

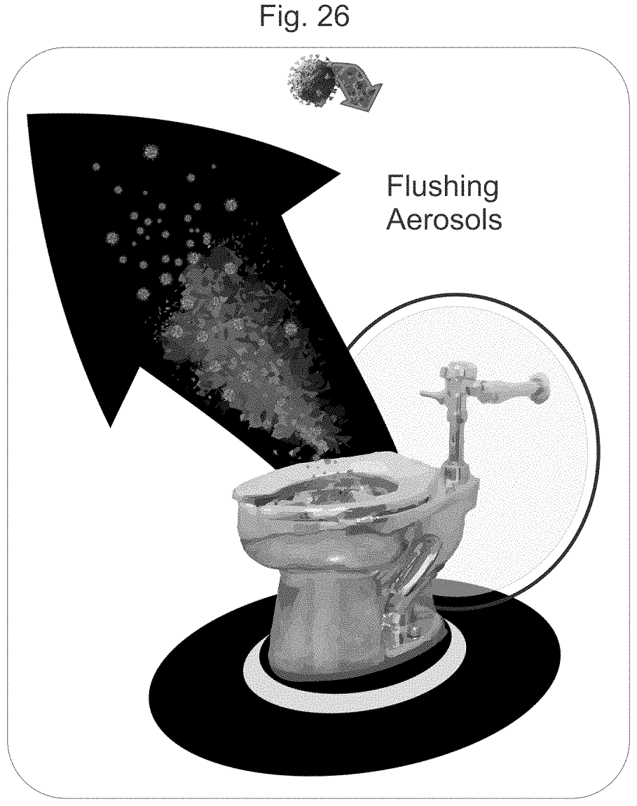

(Method of Use—Additional Benefits of Process) The D-Lav Machine/Mechanism invention is a flush-less, low water and human stooping sanitation process that mitigates aerosol droplets known to be generated via toilet flushing that could result in the propagation/spray and spread of viruses [Covid-19 for example, FIG. 26)], by infected fecal matter during regular toilet flushing. As determined by an NIH study, “Shedding of SARS-CoV-2 in feces and urine and its potential role in person-to-person transmission and the environment-based spread of COVID-19”. It determined that fecal shedding of the virus peaks in the symptomatic period and can persist for several weeks, but with declining abundances in the post-symptomatic phase. SARS-CoV-2 RNA is occasionally detected in urine, but reports in fecal samples are more frequent. The D-Lav Machine/Mechanism invention offers a method of mitigating viruses and other infectious diseases from entering the environment via a decentralized/flush-less sanitation system that utilizes detritivores, FIG. 19). Which consume human wastes and bio-converts them into substances which have anti-viral properties. The D-Lav Machine/Mechanism also is a sanitation system that mitigates/prevents aerosolized urine droplets [and flatulent dispersals] from spreading viral sprays, such as Covid-19. Via oral/ocular routs via a twin fan air suction system positioned alongside the mechanism/machine's urinal containment apparatus, FIGS. 5-24b & 24c) and (25).

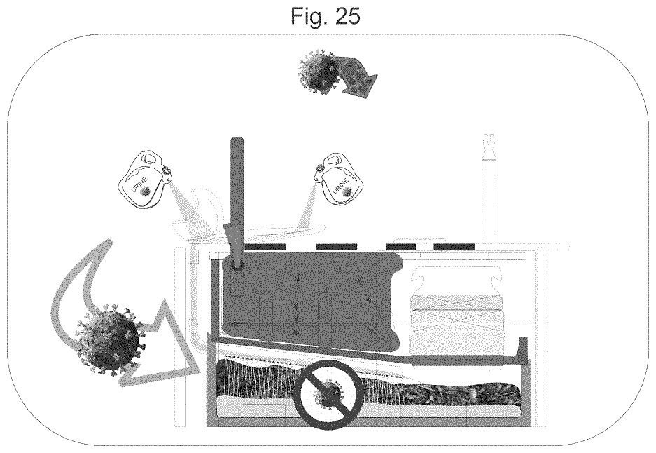

The D-Lav Machine/Mechanism also acts as an environmentally beneficial machine, By preventing human wastes from entering into the environment, FIGS. 25) and (26). Either by aerosol, septic or pit latrine, processing plants or the outdoors, FIGS. 26) and (28). Thus, reducing significantly human environmental impacts. By performing this function the D-Lav Machine/Mechanism mitigates Carbon Dioxide, Methane and Nitrous Oxide from being emitted into the atmosphere, FIG. 19).

Finally, the D-Lav Machine/Mechanism also functions as a commodity production machine. Through the bio-conversion of human feces, urine, hair, menstrual blood and biodegradable paper products, the detritivores [black soldier-fly larvae and earth worms] act as change agents. Bio-converting such materials into viable products, Such as animal teed, fertilizers and nutrient dense soils.

What is being claimed is:

1. a) the D-Lav Sanitation Machine/Mechanism a bio-conversion machine/mechanism comprising; b) a rectangular shaped structure with stair-step access forward and rear pylons surrounding a compartment of an efficiently aerated detritovore and biochar core; c) that receives human and food waste items in two stage containers consisting of black soldier-fly larvae, earthworms and biochar [first stage]; d) and a collection bin of olivine treated biochar [second stage]; e) that culminates into a flush-less and decentrally compartmentalized/sanitized system that is composed of; f) an antiviral coating; g) ‘tippy tap’ soap and water appliance jugs dispensers; h) that also has installed mini-fans within the mechanism's support bars for effective evacuation of aerosols and internal aeration for the detritivores.

2. a mechanism according to [claim 1] of where; a) human solid to liquid bio-waste and food scraps that is disposed into the mechanism's detritovore and olivine treated biochar bins for multi-functional processing; b) through detritivores (black soldier-flies and earth worms) and olivine treated biochar according to [claim 1], which actively bio-converts said waste materials into c) viable commodities such as nutrient dense soils, animal feed and fertilizers; d) where detritivores further act to consume human bio-wastes that may contain bacterial or virus infected feces or urine; e) performed upon an anti-bacterial and anti-viral surfaced mechanism further reducing the likely spread of infectious disease.

3. a) with the D-Lav Sanitation Machine/Mechanism according to [claim 1] of where; by the effect of its bio-conversion of human bio-wastes, the Machine/Mechanism will eliminate the usual resulting human wastes sourced pollutants in the surrounding environment; thus, avoiding the use of landfills, waste treatment plants or unofficial dumping areas; thereby also effectively b) mitigating Carbon Dioxides [CO2], Methane [CH4] and Nitrous Oxides [NO2] from entering the atmosphere.

4. a) the D-Lav Sanitation Machine/Mechanism according to [claim 1] where; the Mechanism possesses a Feed Efficiency Light Herding Self Harvesting Pagoda Platform(s) b) that involves the utilization of a series of clear (see through) canopies illuminated by the D-Lav clear surface that will motivate adult black soldier-flies (with a maximum of six lumens of light to avoid) along with further comprising c) adjacent to the self-harvesting tube will be treated with a drying agent underneath, that will assist in the herding of the mature black soldier-fly larvae towards an exit; d) so that the younger larvae will be able to more readily and efficiently consume human waste materials in their containment bin.
